(19) United States
(12) Patent Application Publication
(10) Pub. No.: US 2005/0173339 A1
(43) Pub. Date: Aug. 11, 2005

(54) Sludge elimination system

(76) Inventor: John R. Sheaffer, Wheaton, IL (US)

Correspondence Address: David M. Mundt, Esq.;Cook, Alex, McFarron, Manzo,, Cummings & Mehler, Ltd., 200 West Adams Street, Suite 2850, Chicago, IL, 60606, US

(21) Appl. No.: 10/774,097

(22) Filed: Feb. 6, 2004

(51) Int. Cl. C02F 11/02

(52) U.S. Cl. 210/605

(57) ABSTRACT

A sludge elimination system, particularly adapted to process the waste activated sludge from a standard activated sludge plant, has three treatment cells. Each of the treatment cells has an anaerobic zone and an aerobic zone above it. Effluent from the facility is introduced into the anaerobic zone in the first cell; the aerobic zone of the first cell has a fluid connection to the anaerobic zone of the next cell, and so on. Residence times are preferably 140, 20 and 20 days per cell. The aerobic zone is created by the injection of air with coarse aerators. Oxygen introduced by the aeration reduces the volatiles and clean water eventually exits the system.

### FIELD OF THE INVENTION

The present invention relates in general to waste treatment systems, and more particularly to the elimination of solids contained in the waste activated sludge generated by a standard activated sludge plant or sewage treatment system.

### BACKGROUND OF THE INVENTION

One of the great advances of human civilization was the realization that improper treatment of human and animal waste leads to pollution of otherwise potable water supplies and, perhaps more importantly, leads to disease. From this realization sprang numerous waste treatment systems. From the residential, business and light industrial realm sprang municipal collection and treatment systems.

The municipal sewage system is a network of sanitary sewers connecting all of the residences, businesses and institutions in a municipality to a central sewage treatment plant which produces sludge (biomass) and effluent that is discharged into a river or other body of water. Often, this effluent has high nutrient levels, leading to undesirable eutrophic activity in the body of water into which the effluent is discharged, producing algal blooms, decreased oxygen concentration levels, fish kills and undesirable odors. Another byproduct of the typical municipal activated sludge plant is waste activated sludge (WAS) which must be disposed of by incineration, ocean dumping, burial in a landfill, or spread on (incorporated into) agricultural fields.

Since Congress prohibited the ocean dumping of sludge in 1992, and air quality constraints have reduced the practice of incineration, the use of sludge as fertilizer has increased rapidly. However, this practice has triggered controversy regarding the safety of incorporating sludge into agricultural fields. To that end, hundreds of complaints have been documented over the last decade, including accusations that the toxic chemicals and pathogens have caused sickness and death in humans and animals alike.

Conventional activated sludge treatment of wastewater generates excess sludge, bio-solids, or WAS which must be managed or relocated. Proper management of these bio-solids must address concerns about odors, pathogens, trace elements, and oxygen demand. Traditionally, bio-solids management, which focuses on stabilization and dewatering, results in some volume reduction, but substantial effort and cost still goes into managing the residual materials. Examples of such management are disclosed in U.S. Pat. Nos. 6,068,773 and 6,136,185, both of common inventorship to one another and the present invention and are incorporated herein by reference.

Included within most wastewater are numerous pharmaceuticals such as antibiotics, anti-epileptics, analgesics, blood lipid regulators, B-blockers, etc. There are concerns that these xenobiotic compounds could interact with and potentially disrupt endocrine systems in animals and humans. Chronic effects from exposure to low concentration may not be apparent for years. Concerns remain about these compounds, their degradation products and their metabolites, especially because many pharmaceuticals and personal care products are not completely degradeable or removed during conventional wastewater treatment.

The biomass known as sludge generally consists of 3 percent solids and 97 percent water. A portion of the sludge, 30 percent, is recycled in the particular treatment process while the remaining 70 percent is deemed waste-activated sludge (WAS) and is the product that none of the current practices adequately dispose of. Accordingly, it is a general object of the present invention to provide an improved system to process WAS.

It is another general object of the present invention to provide for a totally different approach in sludge handling.

It is another object of the present invention to provide a system to process WAS and essentially return clean water.

It is a more specific object of the present invention to provide a system to eliminate the solids contained in the WAS.

Another object of the present invention is to provide a treatment of bio-solids that offers an economic benefit over the conventional relocation and deposit process.

Still a more specific object of the present invention is to provide a system which utilizes both time and air to minimize or eliminate the organic solids in the WAS so that all that remains is water.

Yet another object of the present invention is to provide an improved system for biological degradation of pharmaceuticals.

These and other objects, features and advantages of the present invention will be clearly understood through consideration of the following detailed description.

### SUMMARY OF THE INVENTION

According to the present invention, there is provided a system and method of eliminating sludge. The system includes three treatment cells whereby the sludge effluent will be treated aerobically and anaerobically each for predetermined periods of time, as it moves laterally through the cells in a plug-flow fashion.

### BRIEF DESCRIPTION OF THE DRAWINGS

The features of the present invention which are believed to be novel, are set forth with particularity in the appended claims. The invention, together with the further objects and advantages thereof, may best be understood by reference to the following description taken in conjunction with the accompanying drawings, in the several figures of which like reference numerals identify like elements, and in which:

FIG. 1 is a schematic diagram illustrating the different components of the sludge elimination system according to the invention;

FIG. 2 is a process flow diagram illustrating the sludge elimination process according to the invention; and

FIG. 3 is a scale of waste conversion efficiency E with respect to time of any of the treatment cells according to a preferred embodiment of the invention.

### DETAILED DESCRIPTION OF THE PREFERRED EMBODIMENT

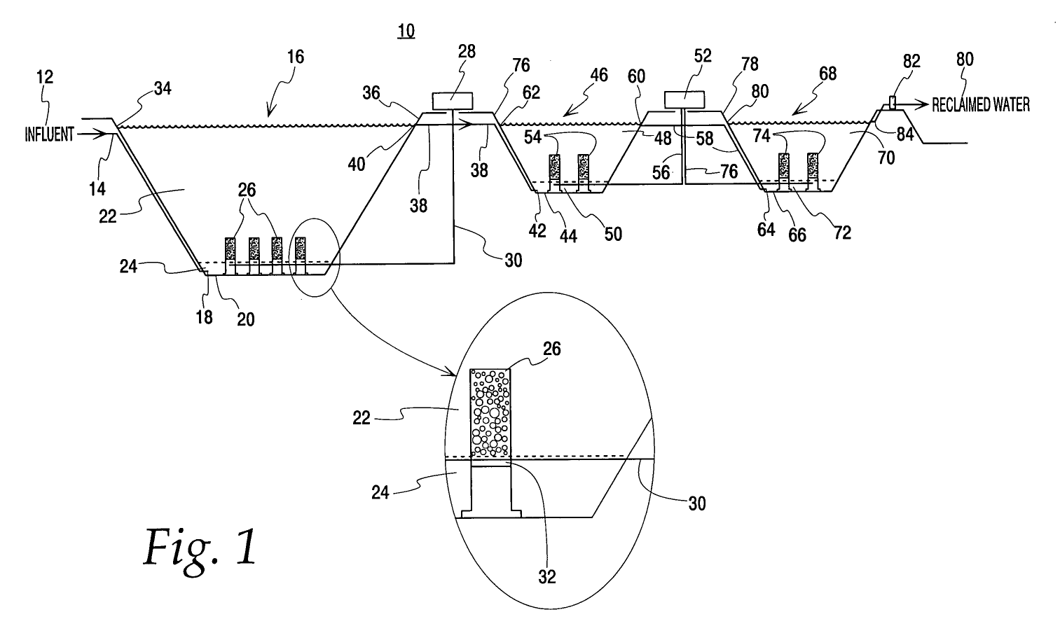

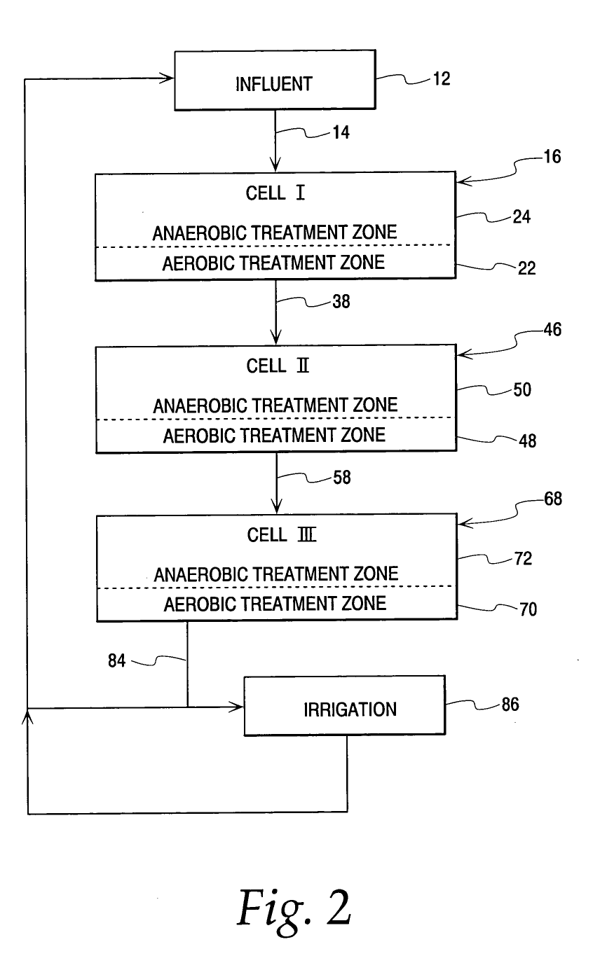

FIG. 1 illustrates the basic components of the sludge elimination system 10 according to the invention and FIG. 2 shows a corresponding process flow diagram. The preferred embodiment will be described with respect to waste activated sludge (WAS) in general, but it will be understood that the influent of this system may be generated by a standard activated sludge plant, or other source.

Whatever the origin, the influent 12 is flushed into a conduit 14 which leads to a first treatment cell indicated generally at 16. More specifically, an end 18 or the conduit 14 is located at or near the bottom 20 of the first cell 16. This first cell 16 preferably has a volume of 8,000,000 gallons and is divided into a top aeration zone 22, having a volume of approximately 7,500,000 gallons, and a bottom anaerobic zone 24, having a volume of approximately 500,000 gallons. The cell 16 has installed therein a plurality of static tube aerators 26. While four such aerators 26 appear in the schematic illustration of FIG. 1, the preferred embodiment has 225, and a larger-scale operation may have many hundreds of such aerators 26 in cell 16, which are horizontally spaced apart from each other. A source of compressed air, preferably three 3,000 cubic feet per minute (cfm) centrifugal blowers 28, provides compressed air in a conduit 30 to each of the aerators 26. The conduit 30 should be built of a material which can withstand relatively high air temperatures caused by compression of the air; steel and ductile iron are possibilities. The conduit 30 has openings 32 beneath the aerators 26, such that air is emitted into the first cell 16 at an elevation above the floor 20, but substantially below a third elevation 34.

Most of the cell 16 depth is given over to a combination of the aerobic zone 22 and the anaerobic zone 24. However, a freeboard area 36 is provided which extends the sidewall of the first cell 16 above the third elevation 34. In the preferred embodiment, about two feet of freeboard is provided. The elevation 34 is one around which the actual water level will cycle, the expected variation being a number of inches. Suitable means, such as liners or natural waterproof well materials such as bentonite or other fluid-impermeable clays, are used to seal the cells from each other and from the water table.

A further conduit 38 has a first end 40 in the first cell 16 at a location not far below the planned surface elevation 34. Conduit 38 has its other end 42 disposed at or near a bottom 44 of a second cell indicated generally at 46. The second cell 46 is similar in overall function to the first cell 16. However, because the fluid introduced by conduit 42 will have less objectionable materials (including BOD₅—discussed later), the aerobic zone 48 of it need not be as deep as the aerobic zone 22 of cell 16. The anaerobic zone 50 and the aerobic zone 22 are effectively divided one from the other so that the only communication between the two is made through pipe 38.

This second cell 46 has a volume of approximately 1,000,000 gallons and is divided into a top aeration zone 48, having a volume of approximately 900,000, and a bottom anaerobic zone 50, having a volume of approximately 100,000 gallons. Cell 46 has aeration equipment installed in it as well, and in the preferred embodiment the aeration comes from two 700 cfm positive displacement blowers 52 that provide the air into preferably twenty-five aerators 54 through pipe 56. The pipe 56 will be at a predetermined elevation from the floor, which in the preferred embodiment is the same as the elevation of the pipe in cell 16, particularly with respect to the orifices 32 at which air bubbles come out of it.

A conduit 58 has a first end 60 disposed in the second cell 46 to be slightly below a planned water elevational level 62. The opposite end 64 of the conduit 58 is placed at or near the bottom 66 of a third cell indicated generally at 68. The third cell 68, much like the second cell 46, is similar in overall function to the first cell 16, but with once again, even less objectionable material. The aerobic zone 70 and anaerobic zone 72 of cell 68 are in fact preferably the same as cell 46. The anaerobic zone 72 and the aerobic zone 48 being effectively divided one from the other so that the only communication between the two is made through pipe 58.

This third cell 68 has a volume of approximately 1,000,000 gallons and is divided into a top aeration zone 70, having a volume of approximately 900,000 gallons, and a bottom anaerobic zone 72, having a volume of approximately 100,000 gallons. Cell 68 has aeration equipment installed in it as well, and in the preferred embodiment the aeration comes from the same two 700 cfm positive displacement blowers 52 that provide air to aerators in cell 46. These blowers 52 now also provide air into preferably ten aerators 74 through pipe 76. The pipe 76 will be at a predetermined elevation from the floor, which in the preferred embodiment is the same as the elevation of the pipe in cell 16 and cell 46, particularly with respect to the orifices 32 at which air bubbles come out of it.

Much like cell 16, freeboard area 76, 78 in cells 46 and 68 respectively, is provided which extends the sidewall of the second cell 46 above its third elevation 62 and the third cell 68 above its third elevation 80. In the preferred embodiment, about two feet of freeboard is provided with suitable areas to seal as previously discussed.

Reclaimed water 80 from cell 68 is withdrawn by a pump 82 through conduit 84. The pump 82, in conjunction with appropriate valving, pumps the reclaimed water 80, originally WAS influent 12, to the head of the treatment process where it will dilute the influent 12, or where it can be used as irrigation water 86 on landscaping or crops.

The biomass processed by this system 10 is quantified in the art as BOD—short for “biochemical oxygen demand.” BOD is the amount of oxygen used by micro-organisms when they biodegrade organic material in a water sample. It is used as a measure of the degree of water contamination. The amount of biomass measured by the BOD₅ method is determined by taking a quantity of the biomass, subjecting it to oxygen for five days, measuring the amount of oxygen which is consumed by the biomass during that time, and correlating the measured oxygen consumption to a mass quantity for the biomass.

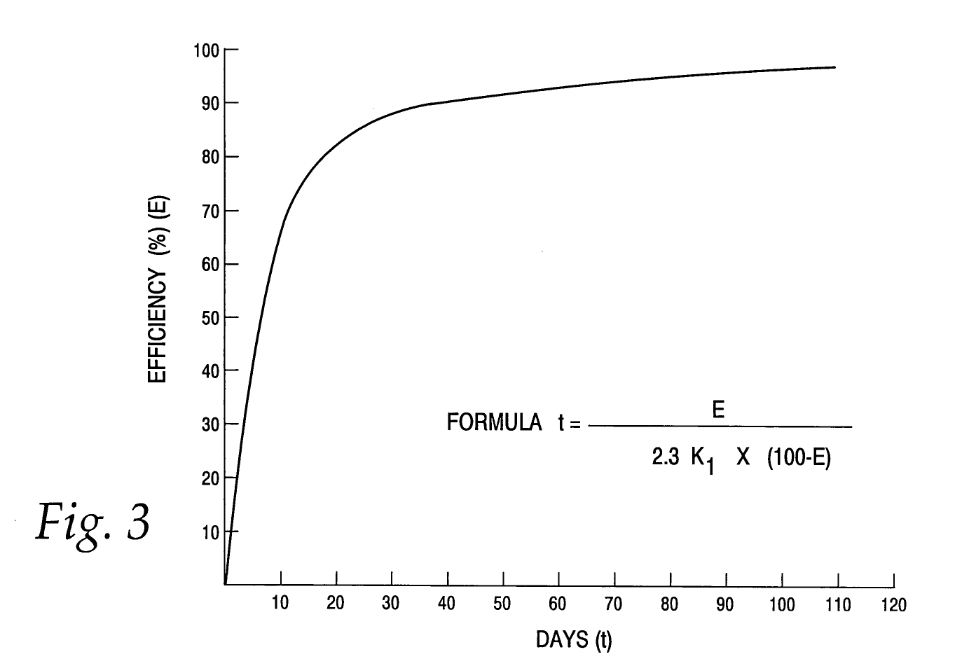

BOD₅ calculations for a solid reduction facility using cells much like the present invention have been defined in a number of texts, including “Recommended Standards for Wastewater Facilities”, also known as the “Ten States Standards.” Whatever the media, it has been discovered that the amount of conversion inside the cells is not linearly related to the residence time, but rather by the following formula:

$$\vert t = \frac{E}{2.3 {K}_{1} ( 100 - E )} \vert$$

where t is the time in days, E is the percent of BOD₅ converted, and K, (reaction coefficient) is 0.12 in warm weather and 0.06 in cold weather. FIG. 3 is a graph of this conversion efficiency. From this graph it is understood that a large amount of the BOD₅ occurs within the first ten days. After this, the conversion of further amounts, although not nominal, drops off significantly.

If the inventor has discovered that one will get a more effective BOD₅ conversion, if one uses multiple cells which are isolated from each other than if one uses a single cell having a volume as large as the two cells put together. Further, the use of multiple cells will allow the operator to take advantage of the aforementioned relatively quick conversion rates.

A five million (5,000,000) gallons per day (mgd) activated sludge plant that produces 50,000 gallons per day (gpd) of WAS with a BOD₅ of 20,000 mg/l can now be used as an example to illustrate the workability of the present sludge elimination system. To minimize or eliminate the solid portion of the sludge, a three-cell system as presented in FIG. 1 will be used to break down the organic solids. The first cell 16 will have 10 days of anaerobic treatment and 140 days of aerated, or aerobic, treatment time. The second cell 46 will have one day of anaerobic treatment and 20 days of aerobic treatment time and the third cell 68 will have 1 day of anaerobic treatment and 20 days of aerobic treatment time. In total, the treatment time consists of 12 days of anaerobic processing and 180 days of aerobic processing in three sequences of anaerobic/aerobic treatment. The present sludge elimination system can therefore provide the long treatment process of 180 days because approximately only 1% of the original volume of the influent 12 becomes WAS.

In each of the three treatment cells (16,46,68) of the preferred embodiment, the following processes take place: anaerobic decomposition, aerobic biological treatment, mixing, and chemical oxidation. The comersion efficiency equation, previously discussed, can be used to determine the BOD₅ removals for the aerobic portion of the three treatment cells. Using this equation, the performance of the present sludge elimination system in this example is as follows:

The design flow if this example is 50,000 gpd of WAS with
a BOD₅ of 20,000 mg/L and 8,345 lbs/day.

| | | | | | |
|---|---|---|---|---|---|
| | | | Effluent | lbs. BOD₅ | lbs. BOD₅ |
| t (days) | K | E | mg/L | removed/day | remaining |

WARM WEATHER

| | | | | | | |
|---|---|---|---|---|---|---|
| CELL I | 140 | 0.12 | 97.48% | 504 | 8,135 | 210 |
| CELL II | 20 | 0.12 | 84.66% | 77 | 178 | 32 |
| CELL III | 20 | 0.12 | 84.66% | 12 | 27 | 5 |

TOTAL BOD₅ REMOVED, 8,340 lbs/day

COLD WEATHER

| | | | | | | |
|---|---|---|---|---|---|---|
| CELL I | 140 | 0.06 | 95.08% | 984 | 7,935 | 410 |
| CELL II | 20 | 0.06 | 73.40% | 261 | 301 | 109 |
| CELL III | 20 | 0.06 | 73.40% | 69 | 80 | 29 |

TOTAL BOD₅ REMOVED 8,316 lbs/day

In addition to the BOD₅ removed in the 180 days of aerobic treatment illustrated above, there is a reduction of BOD₅ in the 12 days of anaerobic treatment. The reduction in the anaerobic zone further reduces the residual BOD₅ load and provides a margin of safety for the present sludge elimination system. With only 5 lbs. of the 8,345 lbs. per day remaining, the sludge elimination system reduces the BOD₅ by 99.94% in the aerobic zones in the warm weather. In cold weather, the 8,345 lbs. of BOD₅ is reduced to 29 lbs., a 99.5% reduction. Furthermore, the flow from the sludge elimination system will have a BOD₅ loading of less than 12 mg/l in the warm weather and 70 mg/l in the cold weather. The reclaimed water 80, originally WAS, can be returned to the head of the treatment process where it will dilute the influent wastewater, which will have a BOD₅ loading from 250 to 300 mg/l, or it can be used as irrigation water for landscaping or crops.

The elements of the preferred sludge elimination system can now be described as they relate to FIGS. 1-3 and the subject example. In particular, the WAS flows by gravity to the bottom 20 of Treatment Cell I 16. The bottom 5 feet of the cells is an anaerobic zone 24 in which a portion of the organic solids breakdown to CH₄ (methane), CO₂ (carbon dioxide), H₂S (hydrogen sulfide), N₂ (nitrogen gas) and H₂O (water). The anaerobic zone 24 provides 10 days of residence time. Air is introduced into the treatment cell above the 5 foot anaerobic zone. Three 3,000 cubic feet per minute (cfm) centrifugal blowers 28 introduce the compressed air through 225 static tube aerators 26 into the aerobic zone 22. The gases created through decomposition of solids in the anaerobic zone 24 are soluble in the aerobic zone 22. The odorous element of decomposition, H₂S, converts to the odorous form of SO₄ (sulfate) in the aerobic zone 22. Because the WAS is not exposed to the atmosphere there are no nuisance odors emitted from the system.

Since the organic solids are being converted to soluble gases and water, the solids in the WAS are being eliminated. The WAS moves laterally through the reclamation cells in a plug-flow fashion. The head end of reclamation Cell I 16 is the heaviest aeration/mixing section, where the WAS is injected. The closest spacing of aerators 26 is located in this section, providing the best balance between energy for oxygen and energy for mixing. This balance optimizes reactions between the micro-organisms and the WAS. The soluble biodegradable organic materials in the WAS, which are suspended solids in the high energy/mixing section, are metabolized quickly into microbial cells. The oxidation of soluble gas released from the anaerobic zone is maximized in this aeration/mixing section of Cell I 16. As the WAS moves through Cell I 16, mixing and aeration energy are reduced by increasing the spacing between the aerators 26. This promotes the stabilization of the remaining biodegradable organic solids. Microbial solids are reduced by endogenous respiration. The mixing action in this section is designed to carry the suspended solids throughout the cell, maximizing oxygen transfer. Heavier solids also settle back into the anaerobic zone 24, where the conversion by digestion into soluble gases continues. The combination of the heavy aeration/mixing and prolonged respiration in Cell I 16 significantly reduces the suspended solids and BOD.

After the 140 day aerobic treatment period in Cell I 16, the wastewater flows from near the top of the Cell I 16 into the bottom 44 of Cell II 46 by gravity. In Cell II 46, there is a 5 foot anaerobic zone 50 and a 15 foot aerobic zone 48. Two 700 cfm positive displacement blowers 52 provide the air into Cell II 46 and Cell III 68 through 35 static tube aerators (59, 74), 25 in Cell II 46 and 10 in Cell III 68. There is a tapered aeration in the two cells. Cells II 46 and III 68 each provide 1 day of anaerobic treatment and 15 days of aerobic treatment. In total, there are 12 days of anaerobic treatment and 180 days of aerobic treatment. This prolonged treatment time effectively reduces the solids in the WAS. The extended residence time coupled with combined anaerobic-aerobic treatment results in nearly complete mineralization of biosolids. The carbon component of the biosolids is oxidized to carbon dioxide. Recalcitrant organic matter is converted to soluble organic acids that are oxidized in the aerobic zone. The design of the deep aerated reclamation cells is based in the flows and loading rates presented previously in Tables 1 and 2.

In summary, a novel preferably three-cell combination anaerobic/aerobic sludge elimination system has been shown and described. While the invention has been described with the aid of examples and preferred embodiments in the above-detailed description, it will be understood that the invention is not limited thereto, but only by the scope and spirit of the appended claims.

1. A method of eliminating sludge, comprising:
introducing a waste activated sludge effluent into a first cell;
treating said effluent aerobically in said first cell for a first predetermined period of time and anaerobically for a second predetermined period of time;
moving said effluent into a second cell;
treating said effluent aerobically in said second cell for a third predetermined period of time and anaerobically for a forth predetermined period of time;
moving said effluent into a third cell;
treating said effluent aerobically in said third cell for a fifth predetermined period of time and anaerobically for a sixth predetermined period of time; and
reclaiming said effluent as water.
